(19) United States
(12) Patent Application Publication
(10) Pub. No.: US 2005/0279734 A1
(43) Pub. Date: Dec. 22, 2005

(54) Arc runner clinch assembly for electrical switching apparatus

(76) Inventors: Arthur D. Carothers, Beaver Falls, PA (US); Wilbert E. Lindsay, Bulger, PA (US)

Correspondence Address: Martin J. Moran, Esquire;Eaton Electrical, Inc., Technology & Quality Center, 170 Industry Drive, RIDC Park West, Pittsburgh, PA, 15275-1032, US

(21) Appl. No.: 10/870,625

(22) Filed: Jun. 17, 2004

(51) Int. Cl. H01H 9/44

(52) U.S. Cl. 218/40

(57) ABSTRACT

A circuit breaker includes a line terminal conductor, a fixed contact electrically and mechanically connected to the line terminal conductor, and an arc runner disposed on the line terminal conductor adjacent the fixed contact. The arc runner includes a first flat portion abutting a flat portion of the fixed contact, a second elongated and rounded portion adapted to draw an arc from the fixed contact, and a pair of legs clinching the conductor. A circuit breaker operating mechanism cooperates with a movable contact for opening and closing the fixed contact and the movable contact. An arc chute is adjacent the second elongated and rounded portion of the arc runner. A trip unit cooperates with the operating mechanism to trip open the fixed and movable contacts.

### BACKGROUND OF THE INVENTION

1. Field of the Invention

This invention relates to electrical switching apparatus, such as, for example, a circuit breaker, having an arc runner, which transfers an arc from separable contacts to an arc chute where the arc is extinguished. The invention also relates to arc runner assemblies.

2. Background Information

Electrical switching apparatus for power distribution systems include devices such as, for instance, circuit breakers, network protectors, transfer switches and disconnect switches. Power circuit breakers, for example, are typically used to connect a power distribution network to a power source. Such power circuit breakers withstand high currents for a period of time, without tripping, in order to give other circuit breakers in the network time to respond and isolate the fault, thereby localizing disruption of service. Thus, by the time the power circuit breaker responds, it may have to interrupt a sizable current. This results in the drawing of an arc as the circuit breaker contacts open.

It is known to provide an arc chute adjacent to the opening path of the circuit breaker contacts. The arc chute is constructed of a number of spaced apart plates extending transverse to the arc. As the contacts open, the arc is transferred by electromagnetic forces to the arc plates, which cool the arc and increase the arc voltage by breaking it up into sections, both of which help to extinguish the arc.

It is known to employ an arc runner to drive an arc from a stationary contact to an arc chamber. See, for example, U.S. Pat. Nos. 4,229,630; 5,969,314; 6,417,474; and 6,452,470.

U.S. Pat. No. 5,969,314 discloses that a longitudinal vertical slot is disposed into the center of an arc runner in order to provide an attractive edge for the arc to travel toward the center of an arc chute. The edge of the slot encourages the arc to travel up the center of the arc runner, engaging the arc chute near the center and extinguishing the arc sooner.

As shown in FIG. 1, a stationary contact 2 and an adjacent arc runner 4 are disposed on a line terminal conductor 6 of a circuit breaker (not shown). The arc runner 4 is secured to the line terminal conductor 6 by a screw 8. Whenever the circuit breaker movable contact (not shown) separates from the stationary contact 2, the resulting arc (not shown) may stall on the screw slot 10 and, thus, may not be promptly transferred to adjacent arc plates (not shown). Furthermore, this may result in the arc runner 4 blowing off of the line terminal conductor 6.

There is a need, therefore, for electrical switching apparatus with an improved arrangement for extinguishing arcs generated during current interruption.

There is a more specific need for such an improved arrangement for directing the arc from a stationary contact into an arc chute.

Accordingly, there is room for improvement in circuit breakers including arc runners.

### SUMMARY OF THE INVENTION

These needs and others are met by the present invention, which provides an arc runner clinch assembly that employs a clinch joint, as contrasted with a screw, in order to provide a relatively smooth surface to direct an arc from a stationary contact to arc plates of an arc chute.

In accordance with one aspect of the invention, an arc runner clinch assembly comprises: a conductor; a fixed contact connected to the conductor; and an arc runner disposed on the conductor adjacent the fixed contact, the arc runner including a first portion abutting the fixed contact, a second portion adapted to draw an arc from the fixed contact and two legs clinching the conductor.

Each of such legs of the arc runner may include a foot, which is bent to clinch the conductor. The first and second portions of the arc runner may form a longitudinal segment disposed away from the fixed contact.

As another aspect of the invention, an electrical switching apparatus comprises: a conductor; a fixed contact connected to the conductor; an arc runner disposed on the conductor adjacent the fixed contact, the arc runner including a first portion engaging the fixed contact, a second portion adapted to draw an arc from the fixed contact and two legs clinching the conductor; a movable contact; an operating mechanism cooperating with the movable contact for opening and closing the fixed and movable contacts; and an arc chute adjacent the second portion of the arc runner.

The arc runner may have a generally L-shaped profile formed by a longitudinal segment and the legs of the arc runner. The longitudinal segment and the legs of the arc runner may form an opening, which receives the conductor.

As another aspect of the invention, a circuit breaker comprises: a conductor; a fixed contact connected to the conductor; an arc runner disposed on the conductor adjacent the fixed contact, the arc runner including a first portion abutting the fixed contact, a second portion adapted to draw an arc from the fixed contact and means for clinching the conductor; a movable contact; an operating mechanism cooperating with the movable contact for opening and closing the fixed and movable contacts; an arc chute adjacent the second portion of the arc runner; and a trip unit cooperating with the operating mechanism to trip open the fixed and movable contacts.

### BRIEF DESCRIPTION OF THE DRAWINGS

A full understanding of the invention can be gained from the following description of the preferred embodiments when read in conjunction with the accompanying drawings in which:

FIG. 1 is an isometric view of a stationary contact and arc runner assembly of a power circuit breaker.

FIG. 2 is a simplified vertical sectional view of a circuit breaker including an arc runner in accordance with the present invention.

FIG. 3 is a vertical sectional view of another circuit breaker including the arc runner of FIG. 2.

FIG. 4 is an isometric view of the arc runner of FIG. 2.

FIG. 5 is an isometric view of the arc runner, stationary contact and line terminal conductor of FIG. 2, which form an arc runner clinch assembly.

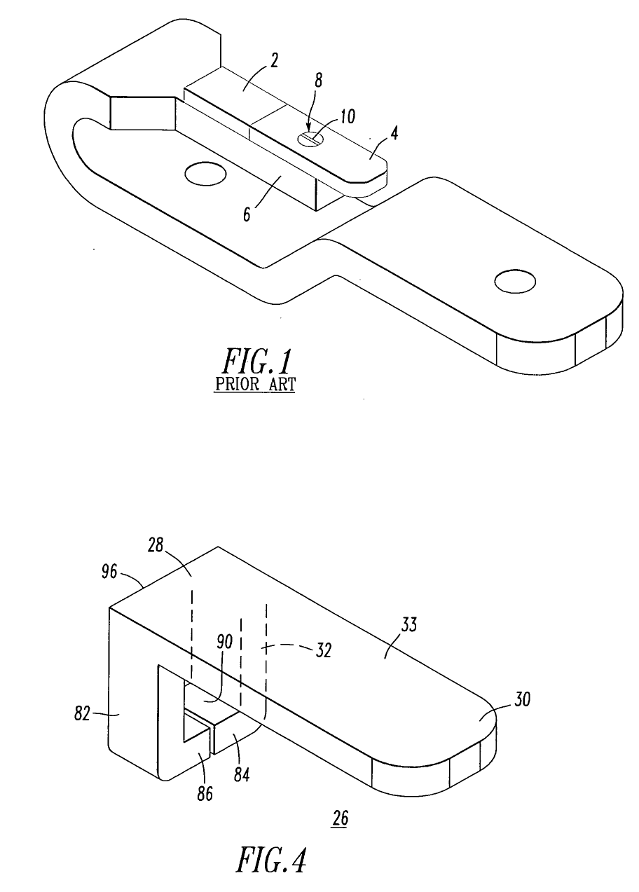

### DESCRIPTION OF THE PREFERRED EMBODIMENTS

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

As employed herein, the term “fastener” shall expressly include, but not be limited to, any suitable fastening member(s) (e.g., without limitation, a threaded fastener; a non-threaded fastener; a removable fastener; a non-removable fastener; a bolt; a machine screw; a rivet; a soldered connection; an adhesive connection), which is employed such that two or more parts are connected or coupled together.

The invention is applicable to electrical switching apparatus such as, for example, circuit breakers, network protectors, transfer switches and disconnect switches having separable contacts, and will be described as applied to a power circuit breaker having separable contacts. An example of a circuit breaker is disclosed in U.S. Pat. No. 6,452,470, which is incorporated by reference herein.

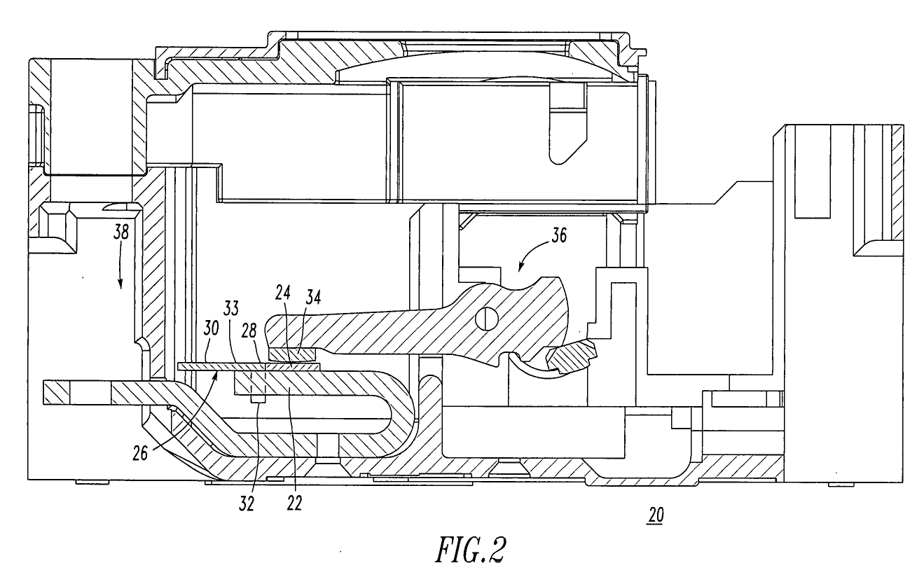

Referring to FIG. 2, an electrical switching apparatus, such as a circuit breaker 20, is shown. The circuit breaker 20 includes a line terminal conductor 22, a fixed contact 24 electrically connected (e.g., welded) to the conductor 22, and an arc runner 26 disposed on the conductor 22 adjacent the fixed contact 24. The arc runner 26 includes a first portion 28 engaging or abutting the fixed contact 24, a second portion 30 adapted to draw an arc from the fixed contact 24, and two legs 32 (e.g., there are two legs in this example, although only one leg 32 is shown in FIG. 2) clinching the conductor 22. As shown, the arc runner 26 has a generally L-shaped profile formed by the legs 32 and by a longitudinal segment 33 including the first and second portions 28,30.

As is conventional, the circuit breaker 20 includes a movable contact 34, an operating mechanism 36 cooperating with the movable contact 34 for opening and closing the fixed and movable contacts 24,34, and an arc chute 38 adjacent the arc runner second portion 30.

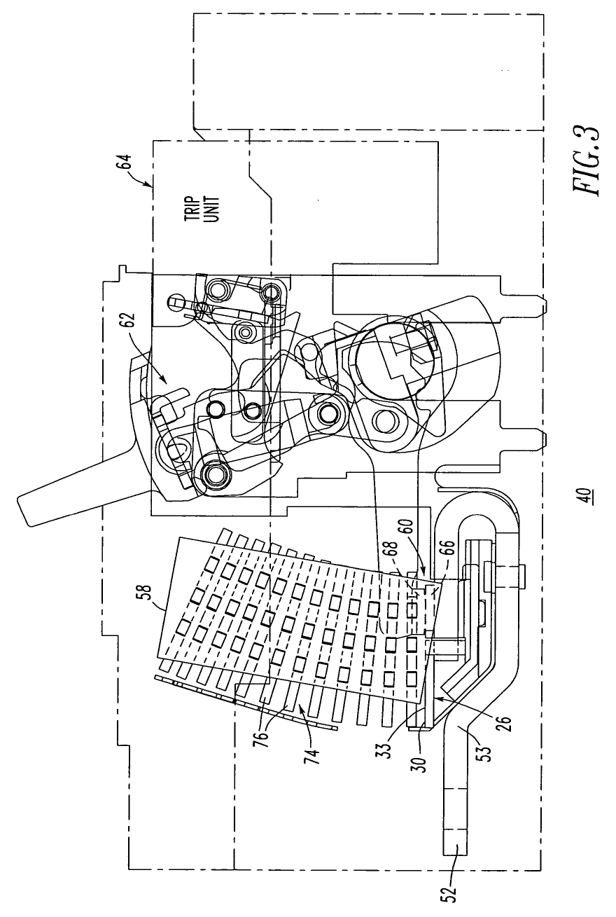

FIG. 3 shows another circuit breaker 40 including the arc runner 26 of FIG. 2. The circuit breaker 40 includes a load terminal (not shown), a line terminal 52 and a line terminal conductor 53. There is shown an arc extinguisher assembly 58, a contact assembly 60, an operating mechanism 62, and a trip mechanism (trip unit) 64. The trip mechanism 64 cooperates with the operating mechanism 62 to trip open the contact assembly 60 including a fixed contact 66 and a movable contact 68. Although not viewable in FIG. 3, each phase of three-phase circuit breaker 40 has its own load terminal, line terminal 52, arc extinguisher assembly 58 and contact assembly 60.

The arc extinguisher assembly 58 includes an arc chute 74 within which are positioned spaced-apart generally parallel angularly offset arc chute plates 76. The arc extinguisher assembly 58 receives and dissipates electrical arcs that are created upon separation of the contacts 66,68 of the circuit breaker 40.

As shown in FIG. 3, the arc runner longitudinal segment 33 is disposed away from the fixed contact 66 below the arc chute 74.

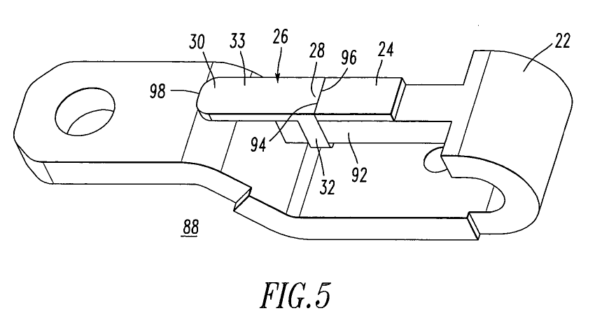

Referring to FIGS. 4 and 5, the arc runner 26 and line terminal conductor 22 are shown. The two legs 32,82 of the arc runner 26 include feet 84,86, respectively, which are bent to clinch the conductor 22. As shown in FIG. 5, the arc runner 26, the line terminal conductor 22 and the fixed contact 24 form an arc runner clinch assembly 88. As was discussed above in connection with FIG. 2, the arc runner 26 is disposed on the conductor 22 adjacent the fixed contact 24. The arc runner first portion 28 abuts the fixed contact 24 and the arc runner second portion 30 is adapted to draw an arc from the fixed contact 24. The arc runner longitudinal segment 33 and legs 32,82 form an opening, such as a generally rectangular opening 90 (FIG. 4), which receives a corresponding portion 92 (FIG. 5) of the conductor 22.

As shown in FIG. 5, the fixed contact 24 includes a first flat portion 94 adjacent the arc runner 26. The arc runner longitudinal segment 33 includes a second flat portion 96 engaging the fixed contact first flat portion 94 and a rounded portion 98 adjacent the arc chute 38 (FIG. 2).

The disclosed arc runner clinch assembly 88 prevents an arc from stalling on the arc runner 26 by employing a relatively smooth longitudinal segment 33. This assembly 88 also provides a material cost reduction and reduces assembly time, since a screw or other separate fastener is eliminated.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. An arc runner clinch assembly comprising:
a conductor;
a fixed contact connected to said conductor, said fixed contact including a first surface; and
an arc runner disposed on said conductor adjacent said fixed contact, said arc runner including a second surface, a first portion abutting said fixed contact, a second portion adapted to draw an arc from said fixed contact and two legs clinching said conductor,
wherein said first surface is proximate to and substantially coextensive with respect to said second surface, said first and second surfaces forming a substantially smooth surface adapted to draw said arc from said fixed contact to said second surface.

2. The arc runner clinch assembly of claim 1 wherein said conductor is a line terminal conductor.

3. The arc runner clinch assembly of claim 1 wherein each of said legs of said arc runner includes a foot, which is bent to clinch said conductor.

4. The arc runner clinch assembly of claim 1 wherein the first and second portions of said arc runner form a longitudinal segment disposed away from said fixed contact.

5. An electrical switching apparatus comprising:
a conductor;
a fixed contact connected to said conductor, said fixed contact including a first surface;
an arc runner disposed on said conductor adjacent said fixed contact, said arc runner including a second surface, a first portion engaging said fixed contact, a second portion adapted to draw an arc from said fixed contact and two legs clinching said conductor;
a movable contact;
an operating mechanism cooperating with said movable contact for opening and closing said fixed and movable contacts; and
an arc chute adjacent the second portion of said arc runner,
wherein said first surface is proximate to and substantially coextensive with respect to said second surface, said first and second surfaces forming a substantially smooth surface adapted to draw said arc from said fixed contact to said second surface to said arc chute.

6. The electrical switching apparatus of claim 5 wherein said conductor is a line terminal conductor.

7. The electrical switching apparatus of claim 5 wherein each of said legs of said arc runner includes a foot, which is bent to clinch said conductor.

8. The electrical switching apparatus of claim 5 wherein the first and second portions of said arc runner form a longitudinal segment disposed between said fixed contact and said arc chute.

9. The electrical switching apparatus of claim 8 wherein said arc runner has a generally L-shaped profile formed by the longitudinal segment and the legs of said arc runner.

10. The electrical switching apparatus of claim 8 wherein the longitudinal segment and the legs of said arc runner form an opening, which receives said conductor.

11. The electrical switching apparatus of claim 5 wherein said fixed contact includes a first flat portion adjacent said arc runner; and wherein said first and second portions of said arc runner form a longitudinal segment including a second flat portion engaging the first flat portion of said fixed contact and a rounded portion adjacent said arc chute.

12. The electrical switching apparatus of claim 5 wherein each of said legs of said arc runner includes a foot, which clinches said conductor.

13. A circuit breaker comprising:
a conductor;
a fixed contact connected to said conductor, said fixed contact including a first planar surface;
an arc runner disposed on said conductor adjacent said fixed contact, said arc runner including a second planar surface, a first portion abutting said fixed contact, a second portion adapted to draw an arc from said fixed contact and means for clinching said conductor;
a movable contact;
an operating mechanism cooperating with said movable contact for opening and closing said fixed and movable contacts;
an arc chute adjacent the second portion of said arc runner; and
a trip unit cooperating with said operating mechanism to trip open said fixed and movable contacts,
wherein said first planar surface is proximate to, substantially coextensive with respect to and co-planar with said second planar surface said first and second planar surfaces forming a substantially smooth planar surface adapted to draw said arc from said fixed contact to said second planar surface to said arc chute.

14. The circuit breaker of claim 13 wherein said conductor is a line terminal conductor.

15. The circuit breaker of claim 13 wherein said means for clinching said conductor includes a pair of legs clinching said conductor.

16. The circuit breaker of claim 13 wherein the first and second portions of said arc runner form a longitudinal segment disposed between said fixed contact and said arc chute.

17. The circuit breaker of claim 16 wherein said means for clinching said conductor includes a pair of legs clinching said conductor; and wherein said arc runner has a generally L-shaped profile formed by the longitudinal segment of said arc runner and said legs.

18. The circuit breaker of claim 16 wherein said means for clinching said conductor includes a pair of legs clinching said conductor; and wherein the longitudinal segment of said arc runner and said legs form an opening, which receives said conductor.

19. The circuit breaker of claim 13 wherein said fixed contact includes a first flat portion adjacent said arc runner; and wherein said first and second portions of said arc runner form a longitudinal segment including a second flat portion engaging the first flat portion of said fixed contact and a rounded portion adjacent said arc chute.

20. The circuit breaker of claim 13 wherein said means for clinching said conductor includes a pair of legs, each of said legs including a foot, which clinches said conductor.
